(19) United States
(12) Patent Application Publication
(10) Pub. No.: US 2013/0110277 A1
(43) Pub. Date: May 2, 2013

(54) COMPONENT MOUNTING APPARATUS, INFORMATION PROCESSING APPARATUS, INFORMATION PROCESSING METHOD, AND PRODUCTION METHOD FOR A SUBSTRATE

(71) Applicant: Sony Corporation, Tokyo (JP)

(72) Inventor: Takao Takano, Saitama (JP)

(73) Assignee: Sony Corporation, Tokyo (JP)

(21) Appl. No.: 13/658,845

(22) Filed: Oct. 24, 2012

(30) Foreign Application Priority Data
Oct. 31, 2011 (JP) 2011-238527

(51) Int. Cl. G05B 11/01

(52) U.S. Cl. 700/121

(57) ABSTRACT

A component mounting apparatus includes a supply unit, a head, and a control unit. The supply unit is configured to supply a plurality of components to be mounted on a substrate, to a predetermined area. The head includes a plurality of holders for holding the plurality of supplied components. The head is configured to support the plurality of holders such that the plurality of holders can simultaneously access the predetermined area. The control unit is configured to calculate, based on position information of the plurality of components with respect to the predetermined area, a combination of at least one or more holding operations necessary for the plurality of holders to hold the plurality of components, the at least one or more holding operations being performed with access positions of the plurality of holders being fixed.

### BACKGROUND

The present disclosure relates to a component mounting apparatus that mounts a component on a substrate, an information processing apparatus, an information processing method, and a production method for a substrate.

A component mounting apparatus is generally an apparatus as follows. Specifically, a head of the component mounting apparatus accesses a feeder that supplies an electronic component, and picks up the electronic component from the feeder. Then, the electronic component is mounted on a circuit substrate or the like that is placed in a mounting area.

For example, Japanese Patent Application Laid-open No. 2008-147313 (hereinafter, referred to as Patent Document 1) describes a component mounting machine including a multi-mounting head 110 and component cassettes 115a (see FIG. 3). In the multi-mounting head 110, a plurality of suction nozzles 111 are arranged. The component cassettes 115a machine are arranged in parallel.

According to descriptions of Patent Document 1, when any suction nozzle 111 or any component cassette 115a stops, a suction method for a component by the multi-mounting head 110 is appropriately controlled. With this, a throughput of the component mounting machine is increased (e.g., see paragraphs [0065]-[0089] of Patent Document 1).

### SUMMARY

For example, in the component mounting machine as shown in FIG. 3 of Patent Document 1, in some cases, components held by the plurality of component cassettes 115a are misaligned with the plurality of nozzles 111. In these cases, it is difficult for the plurality of nozzles 111 to suitably suck the components at the same time, which leads to a low throughput.

In view of the above-mentioned circumstances, there is a need for providing a component mounting apparatus capable of efficiently mounting a plurality of components on a substrate even when the plurality of components supplied to a predetermined area are misaligned, an information processing apparatus, an information processing method, and a production method for a substrate.

According to an embodiment of the present disclosure, there is provided a component mounting apparatus including a supply unit, a head, and a control unit.

The supply unit is configured to supply a plurality of components to be mounted on a substrate, to a predetermined area.

The head includes a plurality of holders for holding the plurality of supplied components. The head is configured to support the plurality of holders such that the plurality of holders can simultaneously access the predetermined area.

The control unit is configured to calculate, based on position information of the plurality of components with respect to the predetermined area, a combination of at least one or more holding operations necessary for the plurality of holders to hold the plurality of components, the at least one or more holding operations being performed with access positions of the plurality of holders being fixed.

In this component mounting apparatus, based on the position information of the plurality of components supplied to the predetermined area, the above-mentioned combination of the at least one or more holding operations necessary for the plurality of holders to hold the plurality of components is calculated. With this, it is possible to efficiently mount the plurality of components on the substrate even when the plurality of components supplied to the predetermined area are misaligned.

The control unit may be configured to select a reference holder to be a reference among the plurality of holders, calculate a candidate combination being the combination of the holding operations with the access position of the reference holder being set to be a position at which the component can be held, and select the combination of the holding operations among a plurality of candidate combinations calculated every time the reference holder is selected among the plurality of holders.

In this component mounting apparatus, the reference holder is selected, and the access position of the reference holder is set to be the position at which the component can be held. Under this setting, the combination of the holding operations for holding the plurality of components is calculated as the candidate combination. For example, the combination of the holding operations is appropriately selected among the plurality of candidate combinations calculated every time the reference holder is selected. With this, it is possible to efficiently mount the plurality of components on the substrate.

The control unit may be configured to calculate the number of holding operations for each of the candidate combinations, and select the combination of the holding operations based on the calculated number of holding operations.

In this component mounting apparatus, the number of holding operations for each of the candidate combinations is calculated. Then, based on the calculated number of holding operations, the combination of the holding operations is selected among the plurality of candidate combinations. Therefore, for example, the candidate combination including a smaller number of holding operations is selected as the combination of the holding operations, and hence it is possible to efficiently mount the plurality of components on the substrate.

The control unit may be configured to determine the access positions of the other holders with the access position of the reference holder is set to be the position at which the component can be held, perform selection of the reference holder and determination of the access positions of the other holders on the holder whose access position is determined not to be located at the position at which the component can be held among the other holders, and calculate the candidate combinations by performing selection of the reference holder and determination of the access positions of the other holders until the access positions of all of the holders are determined to be located at the positions at which the components can be held.

In this component mounting apparatus, until the access positions of all of the holders are determined to be located at the positions at which the components can be held, the selection of the reference holder and the determination of the access positions of the other holders are performed. With this, it is possible to easily calculate the candidate combinations.

The control unit may be configured to calculate, based on information on the kinds of the plurality of components, a range of positions at which the components can be held for each of the kinds, and set the access position of the reference holder to different positions within the range of the positions at which the components can be held multiple times, to thereby calculate the candidate combinations for each of settings at the different positions.

In this manner, the setting of the access position of the reference holder may be performed multiple times. With this, for example, under some settings of the access position, the candidate combination including a smaller number of holding operations may be calculated. As a result, for example, it is possible to calculate a combination of a smaller number of holding operations.

The component mounting apparatus may further include an imaging unit configured to be capable of taking an image of the predetermined area. In this case, the control unit may be configured to obtain the position information of the plurality of components based on the image of the predetermined area that is taken by the imaging unit, to which the plurality of components are supplied.

In this manner, the position information of the plurality of components may be obtained based on the image of the predetermined area to which the plurality of components are supplied. With this, it is possible to obtain correct position information.

The supply unit may be configured to supply, when the plurality of components supplied as first supply are held by the plurality of holders, the plurality of components to the predetermined area as second supply. In this case, the control unit may be configured to obtain information on the holding positions of the plurality of holders with respect to the plurality of components supplied as the first supply, and obtain, based on the information on the holding positions, position information of the plurality of components supplied as the second supply.

In this manner, based on the information on the holding positions of the plurality of holders for the plurality of components supplied as the first supply, the position information of the plurality of components supplied as the second supply may be obtained. With this, the position information of the plurality of components supplied to the predetermined area is obtained for a short time, and hence a throughput is increased.

According to another embodiment of the present disclosure, there is provided an information processing apparatus that is used for a component mounting apparatus including the above-mentioned supply unit and the above-mentioned head. The information processing apparatus includes an acquisition unit and a calculation unit.

The acquisition unit is configured to obtain position information of the plurality of components with respect to the predetermined area.

The calculation unit is configured to calculate, based on the position information obtained by the acquisition unit, a combination of at least one or more holding operations necessary for all of the plurality of holders to hold the plurality of components, the at least one or more holding operations being performed with the access positions of the plurality of holders being fixed.

According to still another embodiment of the present disclosure, there is provided an information processing method that is performed by a component mounting apparatus including the above-mentioned supply unit and the above-mentioned head. The information processing method is as follows.

Position information of the plurality of components with respect to the predetermined area is obtained.

Based on the obtained position information, a combination of at least one or more holding operations necessary for all of the plurality of holders to hold the plurality of components is calculated, the at least one or more holding operations being performed with the access positions of the plurality of holders being fixed.

According to still another embodiment of the present disclosure, there is provided a production method for a substrate that is performed by a component mounting apparatus including the above-mentioned supply unit and the above-mentioned head. The production method is as follows.

Based on position information of the plurality of components with respect to the predetermined area, a combination of at least one or more holding operations necessary for all of the plurality of holders to hold the plurality of components is calculated, the at least one or more holding operations being performed with the access positions of the plurality of holders being fixed.

The plurality of components is held by the plurality of holders with the calculated combination of the holding operations, and the plurality of held components are mounted on the substrate.

As described above, according to the embodiments of the present disclosure, it is possible to efficiently mount a plurality of components on a substrate even when the plurality of components supplied to a predetermined area are misaligned.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a front view schematically showing a component mounting apparatus according to an embodiment of the present disclosure;

FIG. 2 is a plan view of the component mounting apparatus shown in FIG. 1;

FIG. 3 is a side view of the component mounting apparatus shown in FIG. 1;

FIG. 4 is a block diagram showing a configuration of a control system of the component mounting apparatus shown in FIG. 1;

FIG. 5 is a flowchart showing a flow of automatic-production preparation processing according to this embodiment;

FIG. 6 is a flowchart showing a flow of combination estimation processing according to this embodiment;

FIG. 7 is a flowchart showing a detailed flow of the combination estimation shown in FIG. 6;

FIG. 8 is a flowchart showing a flow of automatic production processing according to this embodiment;

FIG. 9 is a schematic view showing examples of six kinds of tape feeders to be mounted to a mounting portion shown in FIG. 2 and electronic components housed in supply windows of the tape feeders;

FIG. 10 is a view showing a case where a suction nozzle of Nozzle Number 1 is set as a first reference nozzle;

FIG. 11 is a view showing the case where the suction nozzle of Nozzle Number 1 is set as the first reference nozzle;

FIG. 12 is a view showing the case where the suction nozzle of Nozzle Number 1 is set as the first reference nozzle;

FIG. 13 is a view showing a case where a suction nozzle of Nozzle Number 2 is set as the first reference nozzle;

FIG. 14 is a view showing the case where the suction nozzle of Nozzle Number 2 is set as the first reference nozzle; and

FIG. 15 is a view showing a holding-operation combination tree in estimation processing according to this embodiment.

### DETAILED DESCRIPTION OF EMBODIMENTS

Hereinafter, an embodiment according to the present technology will be described with reference to the drawings.

[Configuration of Component Mounting Apparatus]

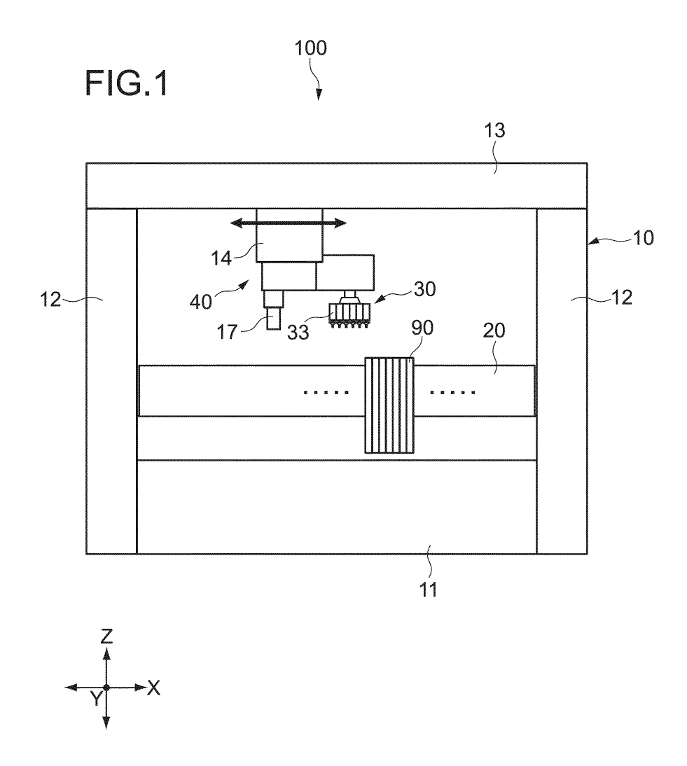

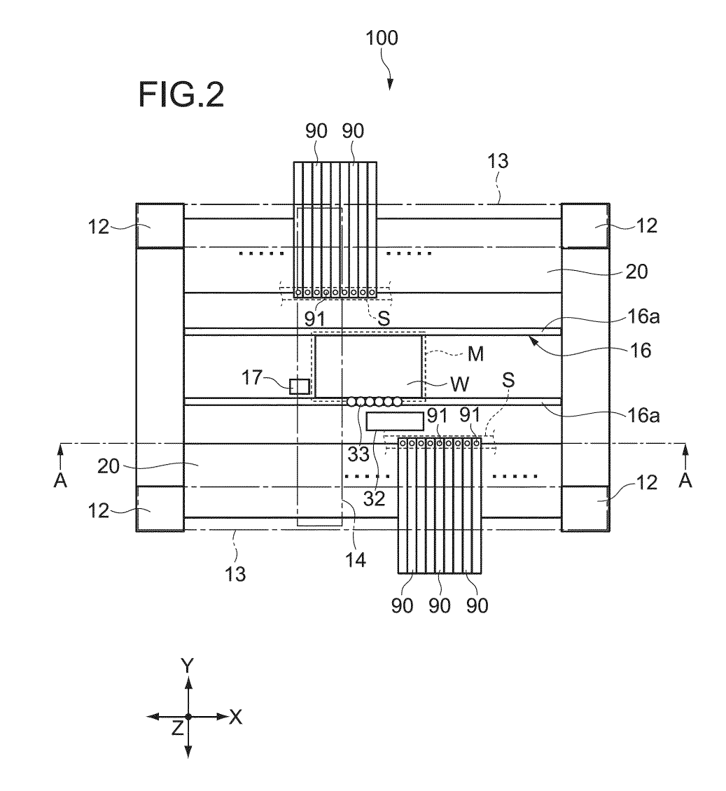

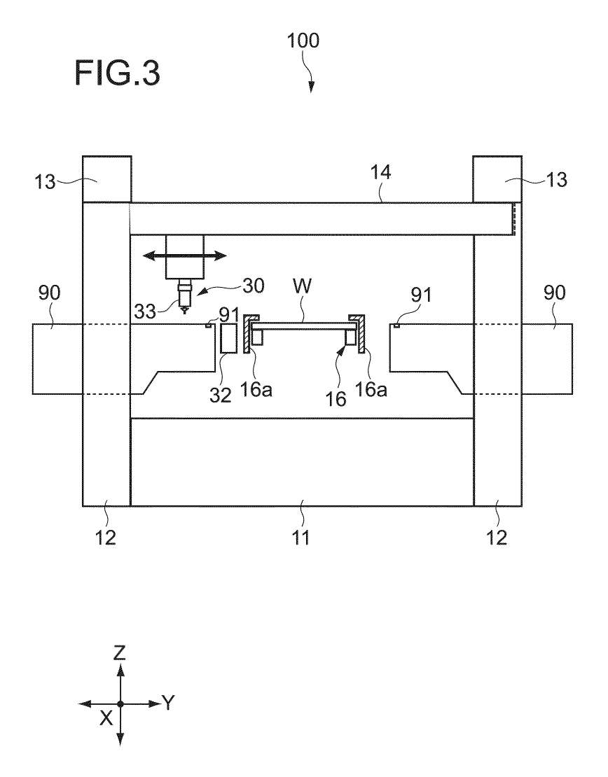

FIG. 1 is a front view schematically showing a component mounting apparatus according to an embodiment of the present disclosure. FIG. 2 is a plan view of a component mounting apparatus 100 shown in FIG. 1. FIG. 3 is a side view thereof.

The component mounting apparatus 100 includes a frame 10, a mounting head 30, mounting portions 20, and a conveyor unit 16. The mounting head 30 holds an electronic component (not shown) and mounts the electronic component on a circuit substrate W (hereinafter, abbreviated as substrate W) that is a mounting target. Tape feeders 90 are attached to the mounting portions 20. The conveyor unit 16 carries and conveys the substrate W (see FIG. 2).

The frame 10 includes a base 11 provided at a bottom thereof and a plurality of pillars 12 fixed on the base 11. The plurality of pillars 12 are, in upper portions thereof, provided with, for example, two X beams 13 bridged along an X-axis in the figures. For example, between the two X beams 13, a Y beam 14 is bridged along a Y-axis. The mounting head 30 is connected to the Y beam 14.

The X beams 13 and the Y beam 14 are provided with an X-axis movement mechanism and a Y-axis movement mechanism (not shown). Those movement mechanisms enable the mounting head 30 to move along the X-axis and the Y-axis. The X-axis movement mechanism and the Y-axis movement mechanism are each typically a ball-screw driving mechanism. However, other mechanisms such as a belt driving mechanism may be employed for those movement mechanisms.

The mounting head 30, the X-axis movement mechanism, and the Y-axis movement mechanism constitute a mounting unit 40. In some cases, a plurality of mounting units 40 are provided in order to enhance productivity. In these cases, a plurality of mounting heads 30 are independently driven in X- and Y-axis directions.

As shown in FIG. 2, the mounting portions 20 are provided both on a front side (lower side in FIG. 2) and a read side (upper side in FIG. 2) of the component mounting apparatus 100. The Y-axis direction in the figures becomes front and rear directions of the component mounting apparatus 100. In the mounting portions 20, the plurality of tape feeders 90 are arranged and attached along the X-axis direction.

For example, 40 to 70 tape feeders 90 are attachable to the mounting portions 20. In this embodiment, a total of 116 tape feeders 90 (58+58 on front side and rear side) are installable. Each of the tape feeders 90 is adapted to house about 100 to 10,000 electronic components, for example.

Although the mounting portions 20 are provided both on the front side and the rear side of the component mounting apparatus 100, the mounting portions 20 may be provided on either one of the front side and the rear side.

Each of the tape feeders 90 is formed to be long in the Y-axis direction and is a cassette-type feeder. Although the tape feeder 90 is not shown in detail in the figures, the tape feeder 90 includes a reel and a carrier tape housing electronic components such as a capacitor, a resistor, an LED (light emitting diode), and an IC (integrated circuit) package is wound around the reel. Further, the tape feeder 90 includes a mechanism for feeding the carrier tape by a step feed. Each step feed feeds one electronic component.

As shown in FIG. 2, the tape feeder 90 has a supply window 91 formed in an upper surface at one end of the cassette thereof. The electronic component is supplied through the supply window 91. An area in which a plurality of supply windows 91 are arranged along the X-axis direction by arranging the plurality of tape feeders 90 serves as a supply area S for the electronic components. That is, the supply area S is an area extending along a conveyance direction for the substrate W.

As described above, in this embodiment, the plurality of tape feeders 90 attached to the mounting portions 20 supply the plurality of electronic components to be mounted on the substrate W, to the supply area S being a predetermined area. Therefore, the plurality of tape feeders 90 function as a supply unit. However, the present disclosure is not limited thereto.

In the center of the component mounting apparatus 100 along the Y-axis direction, the above-mentioned conveyor unit 16 is provided. The conveyor unit 16 conveys the substrate W along the X-axis direction. For example, as shown in FIG. 2, a mounting area M in which the substrate W is placed is provided at an almost center position of the conveyor unit 16 in the X-axis direction. By the mounting head 30 accessing the mounting area M, mounting of the electronic component is performed.

The mounting head 30 includes a plurality of suction nozzles 33 for holding the plurality of electronic components supplied to the supply area S. In this embodiment, the suction nozzles 33 function as a holder. Each of the suction nozzles 33 picks up the electronic component from the carrier tape and holds the electronic component by the action of vacuum suction.

As shown in FIG. 1 and the like, the plurality of suction nozzles 33 are supported by the mounting head 30 to be arranged along the X-axis direction. Position relationship between the plurality of nozzles 33 is fixed in a horizontal direction. Further, the plurality of suction nozzles 33 are movable in upper and lower directions for picking up the electronic component and mounting the electronic components on the substrate W.

Therefore, the plurality of suction nozzles 33 are capable of simultaneously accessing the supply area S, keeping the defined position relationship therebetween. As a result, the plurality of electronic components supplied to the supply area S through the supply windows 91 can be held by the plurality of suction nozzles 33 at the same time. It should be noted that, by moving only some nozzles 33 of the plurality of suction nozzles 33 in the upper and lower directions, component suction by only the some nozzles 33 may be performed.

Here, a component suction operation by all or some suction nozzles 33 under a state in which a position of the mounting head 30 is fixed is defined as a holding operation by the mounting head 30. When the position of the mounting head 30 is fixed, access positions of the plurality of suction nozzles 33 to the supply area S are fixed. Further, when a access position of one suction nozzle 33 is set to be a predetermined position, access positions of the other suction nozzles 33 are fixed.

In this embodiment, a pitch between the plurality of supply windows 91 and a pitch between the plurality of suction nozzles 33 are set to be equal. However, the present disclosure is not limited to this configuration. For example, total width of two or more tape feeders 90 and the pitch between the plurality of suction nozzles 33 may be set to be equal. The length of the pitch, the number of suction nozzles 33, and the like are not also limited, and may be appropriately set.

As long as simultaneous access to the supply area S is possible, the configuration of the plurality of suction nozzles 33 to be attached to the mounting head 30 is not limited to that shown in FIG. 1 and the like. For example, distal end positions of the plurality of nozzles 33 in the Z-axis direction may be different from each other. Further, the plurality of nozzles 33 may be arranged on a straight line oblique to the X-axis direction so that a rotation operation of the mounting head 30 controls operations of the plurality of nozzles 33.

The mounting head 30 is movable in the X- and Y-axis directions as described above. The suction nozzle 33 thereof moves between the supply area S and the mounting area M. Further, the suction nozzle 33 move in the X- and Y-axis directions within mounting area M for the mounting in the mounting area M.

As shown in FIG. 1, the mounting head 30 is equipped with a substrate camera 17 that detects the position of the substrate W. The substrate camera 17 is movable by the X-axis movement mechanism and the Y-axis movement mechanism integrally with the mounting head 30.

In order to detect the position of the substrate W, the substrate camera 17 is placed in an upper portion of the conveyor unit 16 and takes an image of the substrate W from above. The substrate camera 17 recognizes an alignment mark (not shown) provided to the substrate W. Then, the mounting unit 40 mounts the electronic component on the substrate W with such an alignment mark being a reference position.

In this embodiment, the substrate camera 17 is appropriately moved, and hence the image of the supply area S can be taken. Therefore, the substrate camera 17 functions as an imaging unit. When the plurality of electronic components are supplied to the supply area S through the supply windows 91, the image of the supply area S to which the plurality of components have been supplied is taken by the substrate camera 17.

Further, as shown in FIG. 2, the component mounting apparatus 100 includes a component camera 32 provided between the conveyor unit 16 and each of the mounting portions 20. The component camera 32 is capable of imaging the suction nozzles 33 sucking the electronic components from below. For example, when the suction nozzle 33 suck the electronic components, the mounting head 30 is moved and the suction nozzles 33 are transported to above the component camera 32. Then, the component camera 32 images the electronic components held by the suction nozzles 33 from below.

The kinds and configurations of imaging apparatuses used for the substrate camera 17 and the component camera 32 and the positions of the substrate camera 17 and the component camera 32, and the like are not limited. For example, the component camera 32 may be provided to be movable integrally with the mounting head 30. Then, by appropriately using an imaging optical system including a movable mirror and the like, the electronic components sucked by the suction nozzles 33 may be imaged.

Although the conveyor unit 16 is, typically, a belt-type conveyor, the conveyor unit 16 is not limited thereto. Any conveyor may be employed, for example, a roller-type conveyor, a conveyor including a support mechanism that supports the substrate W and slidably moves, or a non-contact type conveyor. The conveyor unit includes guide rails 16a provided along the X-axis direction. With this, the substrate W is conveyed while misalignment thereof in the Y-axis direction being corrected.

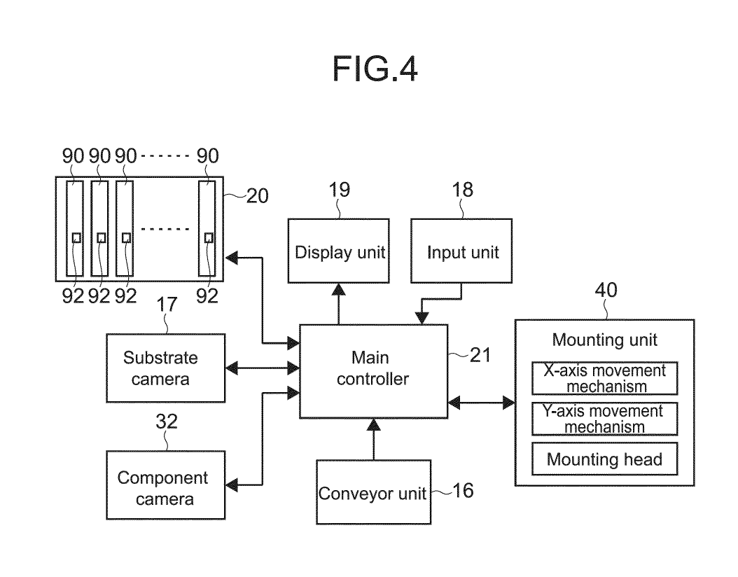

FIG. 4 is a block diagram showing a configuration of a control system of the component mounting apparatus 100.

The control system includes a main controller 21 (or host computer) as a control unit. The mounting portions 20, the tape feeders 90, the substrate camera 17, the component camera 32, the conveyor unit 16, the mounting unit 40, an input unit 18, and a display unit 19 are electrically connected to the main controller 21.

The movement mechanisms and the mounting head 30 of the mounting unit 40 each include a motor (not shown) installed therein and a driver that drives the motor. The main controller 21 outputs control signals to the drivers to drive the movement mechanisms and the mounting head 30 according to the control signals.

The input unit 18 is one to be operated by an operator (user), for example, when the operator inputs information necessary for mounting processing into the main controller 21.

The information necessary for mounting processing includes, for example, information on a substrate to be a mounting target or identification information (tape feeder ID) for identifying the tape feeder 90 that is to be attached to the mounting portion 20 or has been attached thereto. To the identification information of the tape feeder, for example, component information and tape information correspond, which will be described later.

Information on the substrate means information on information on a substrate product. This information includes information on the kind of the substrate to be the mounting target (shape of substrate or the like) and information on the kind, the number, and the like of components necessary for the substrate.

In the single mounting portion 20 of the two front and rear mounting portions 20, for example, as described above, connections (not shown) for a total of 58 tape feeders 90 are arranged. By connecting each tape feeder 90 to each connection, the tape feeder 90 can be attached to the mounting portion 20. When the tape feeder 90 is connected to the connection, the main controller 21 is capable of electrically recognizing which connection (i.e., number of connection) of the mounting portions 20 the tape feeder 90 has been connected to.

The display unit 19 is, for example, one that displays information inputted by the operator via the input unit 18, information necessary for such an input operation, and other necessary information.

The main controller 21 has computer functions, for example, a CPU (central processing unit), a RAM (random access memory), and a ROM (read only memory), and function as a control unit. The main controller 21 may be realized as a PLD (programmable logic device) such as an FPGA (field programmable gate array) or another device such as an ASIC (application specific integrated circuit).

The carrier tape of the single tape feeder 90 houses a number of identical electronic components. The identical electronic components means electronic components of the same kind, for example, “50-pF capacitors.” Capacitors having different capacitances can be considered as different electronic components. Among the tape feeders 90 to be installed into the mounting portions 20, identical electronic components may be housed in a plurality of tape feeders 90.

The tape feeders 90 each include a memory 92. By setting the tape feeder 90 to be connected to the connection of the mounting portion 20, the memory 92 is electrically connected to the main controller 21. The memory 92 stores information on the tape feeders. The information on the tape feeders includes information on the electronic components housed in each of the tape feeders 90 (hereinafter, referred to as component information) and the tape information.

The component information at least includes information on the kind of components, e.g., “50-pF capacitors” as described above.

The tape information includes, for example, information on the length of a tape, the number of housed components, pitches at which the components are housed.

[Operation of Component Mounting Apparatus (Production Method for Substrate)]

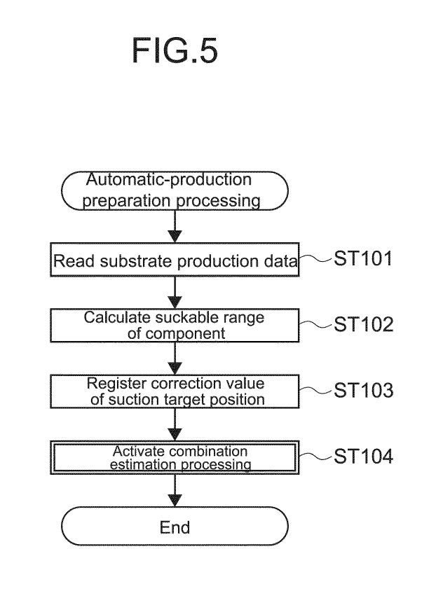

FIGS. 5 to 8 each show an operation of the component mounting apparatus 100. Specifically, FIGS. 5 to 8 each are a flowchart mainly showing processing by the main controller 21.

First, automatic-production preparation processing shown in FIG. 5 is performed. The automatic production processing is processing of producing the substrate W by automatically executing processing including supplying, holding, and mounting of the plurality of components. For preparation of this automatic production processing, the following processing is performed.

Substrate production data is read (Step 101). The substrate production data is the information necessary for mounting processing that includes the information on the substrate W, the identification information of the tape feeder 90, and the like, which has been described above. Based on the identification information of the tape feeder 90, the information on the kind of the electronic components housed in the tape feeder 90 is also read.

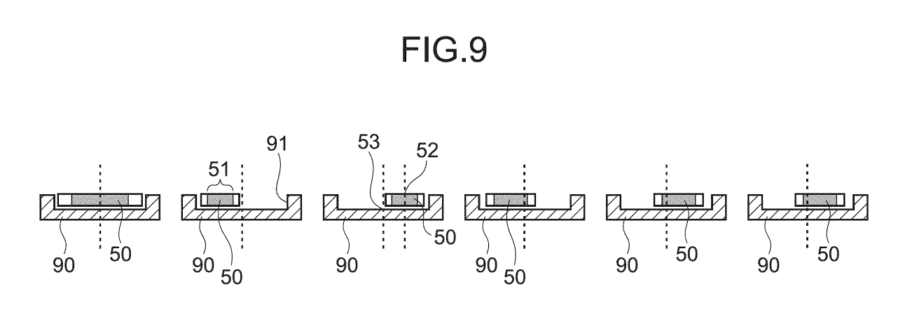

FIG. 9 is a schematic view showing examples of six kinds of tape feeders 90 to be mounted on the mounting portion 20 and the electronic components 50 housed in the supply windows 91 of the tape feeders 90. FIG. 9 corresponds to a cross-sectional view including the tape feeders 90 and the supply windows 91, which is taken along the line A-A shown in FIG. 2.

By reading the substrate production data, what kind of tape feeders 90 are mounted and to which position of the mounting portions 20 and what kind of electronic components 50 are supplied by the tape feeder 90 to the supply area S are recognized.

A suckable range 51 for the electronic component is calculated (Step 102). The suckable range 51 means a range of positions at which the suction nozzle 33 can hold the electronic component 50. When the suction position of the suction nozzle 33 for the electronic component 50 falls within the suckable range 51, the suction nozzle 33 can suck the electronic component 50. The suction position of the suction nozzle 33 corresponds to a holding position.

Typically, the electronic component 50 is sucked by the suction nozzle 33 at a center position 52 as viewed from a suction direction (Z-axis direction). Therefore, the suckable range 51 is, typically, a range extending from the center position 52 of the electronic component 50 to have a predetermined size. For example, an area having a 60% size of the electronic component 50 as viewed from the Z-axis direction is set as the suckable range 51. The percentage for the suckable range 51 is not limited. Further, the setting method for the suckable range 51 is not also limited.

That is, the suckable range 51 may be appropriately sent depending on the size, the shape, the weight, and the like of the electronic component 50. For example, with a light-weight electronic component 50, in many cases, no problems are caused even if the suction position is deviated from the center position 52 of the electronic component 50. On the other hand, with a heavy-weight electronic component 50, if the suction position is deviated from the center position 52, it may be impossible to suck such a component 50. Therefore, for example, with the light-weight electronic component 50, the suckable range 51 is set to be large with respect to the size of the electronic component 50 (e.g., 80%). On the other hand, with the heavy-weight electronic component 50, the suckable range 51 is set to be small (e.g., 40%).

In this embodiment, based on the component information read in Step 101, the suckable range 51 is calculated for each electronic component 50. However, information on the suckable range 51 for each electronic component 50 may be stored on the memory 92 of the tape feeder 90 as the component information in advance. Alternatively, by setting by the operator via the input unit 18, setting, correction, or the like of the suckable range 51 may be performed. The information on the calculated suckable range 51 is, for example, stored on the ROM or the like of the main controller 21.

A correction value for a suction target position is calculated and registered (Step 103). The suction target position means a position to be target to be sucked by the suction nozzle 33 for suitably holding the electronic component 50. By moving an access position of the suction nozzle 33 to the suction target position and making a suction operation, the electronic component 50 is suitably held. In this embodiment, the center position 52 of each electronic component 50 as viewed from the suction direction is set as the suction target position. However, the suction target position is not limited thereto, and another position within the suckable range 51 may be set as the suction target position.

In this embodiment, as an initial setting value of the suction target position, a center position 53 of each supply window 91 to be located in the supply area S is set in advance. That is typically based on the fact that each electronic component 50 is housed in the center of each supply window 91.

However, for example, as shown in FIG. 9, there is a case where the position of the electronic component 50 is misaligned with the supply window 91. In this case, even if the access position is set to be the suction target position (center position 53) defined as the initial setting value, it is difficult to suitably hold the electronic component 50.

Therefore, in Step 103, the correction values for the suction target positions are calculated and corrected suction target positions are calculated. The correction values are calculated based on position information of the plurality of electronic components 50 with respect to the supply area S. Therefore, the corrected suction target positions are calculated based on the position information of the plurality of electronic components 50 with respect to the supply area S.

The position information of the electronic components 50 with respect to the supply area S and information on the suction target position and the like are obtained for each of the electronic components 50 at a coordinate value with the center position 53 of the supply window 91 being a reference, for example. For example, when the electronic component 50 is positioned in the center of the supply window 91, the position information and the suction target position on the electronic component 50 is expressed by (0, 0) and the correction value for the suction target position is also expressed by (0, 0). However, the expressing method for the position information, the reference point of the coordinate system, and the like may be appropriately set.

In this embodiment, in this correction value registration processing performed in the automatic-production preparation processing, the substrate camera 17 is used. The substrate camera 17 takes an image of the supply area S to which the plurality of electronic components 50 have been supplied. By analyzing the image of the supply area S, the position information of each electronic component 50 is obtained. Then, an amount of misalignment of each electronic component 50 with the center position 53 of the supply window 91 is calculated as the correction value. It should be noted that, based on the position information of the electronic component 50, the information on the suction target position may be directly calculated.

Alternatively, the image of the supply area S may be displayed on the display unit 19 and the operator may set or correct the suction target position while viewing the image. Alternatively, a manual operation may move the substrate camera 17 to the center position 52 of the electronic component 50 in the supply area S. Then, this position may be loaded as a component center position and the correction value may be calculated based on such a position.

The obtention of the position information using the image of the supply area S is performed mainly upon mounting or exchanging of the tape feeder 90. Alternatively, such obtention is performed, for example, in the case where the electronic component 50 is failed to be sucked many times during the automatic production.

Combination estimation processing is activated (Step 104). With this, the following processing is performed. Here, only the activation of the combination estimation processing is performed and the automatic-production preparation processing is terminated.

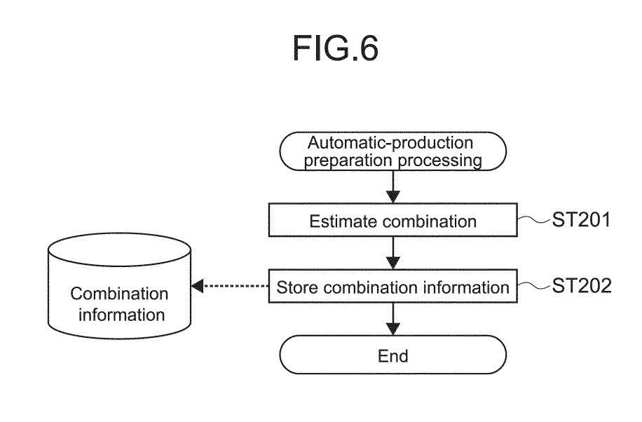

FIG. 6 is a flowchart showing a flow of the combination estimation processing according to this embodiment. The combination estimation processing means processing of estimating a combination of at least one or more holding operations necessary for all of the plurality of suction nozzles 33 to hold the plurality of electronic components 50, the at least one or more holding operations being performed with each of the access positions of the plurality of suction nozzles 33 being fixed.

The combination of the holding operations is estimated (Step 201). Then, information on the combination of the holding operations for sucking the plurality of electronic components 50 is stored on the ROM and the like of the main controller 21 (Step 202). The combination estimation processing in FIG. 6 is performed in parallel with the above-mentioned automatic-production preparation processing and the automatic production processing to be described later.

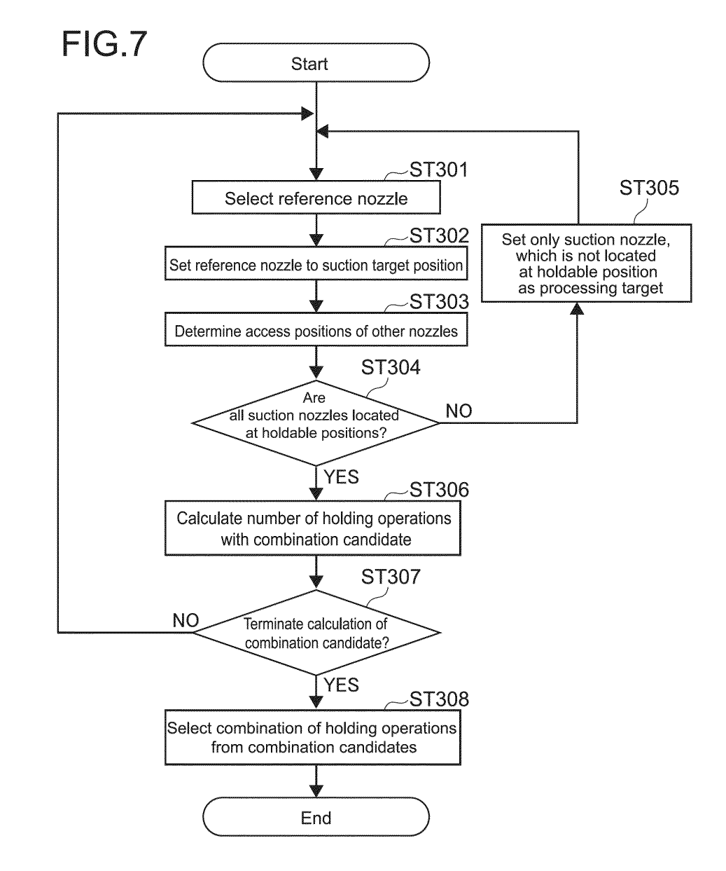

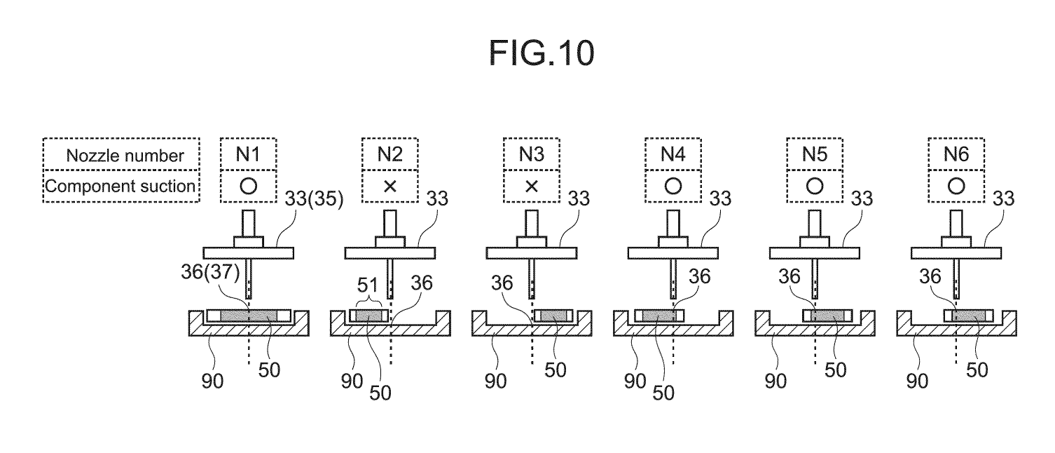

The combination estimation in Step 201 will be described in detail. FIG. 7 is a flowchart showing a detailed flow of the combination estimation. FIGS. 10 to 15 are schematic views for explaining the flowchart.

A reference nozzle 35 functioning as a reference holder is selected among the plurality of suction nozzles 33 (Step 301). As shown in FIG. 10, in this embodiment, the six suction nozzles 33 are each assigned a nozzle number. Then, the leftmost suction nozzle 33 of Nozzle Number 1 is first selected as the reference nozzle 35. However, the selection method and the selection order for the reference nozzle 35 are not limited.

An access position 36 of the reference nozzle 35 is set to be a suction target position 37 at which the electronic component 50 can be held (Step 302). Access positions 36 of the other suction nozzles 33 under this setting are determined (Step 303).

As shown in FIG. 10, when the access position 36 of the reference nozzle 35 is set to be the suction target position 37, the access positions 36 of the suction nozzles 33 of Nozzle Numbers 4 to 6 fall within the suckable range 51. Therefore, those suction nozzles 33 of Nozzle Numbers 4 to 6 are determined to be located at positions at which the electronic components 50 can be held.

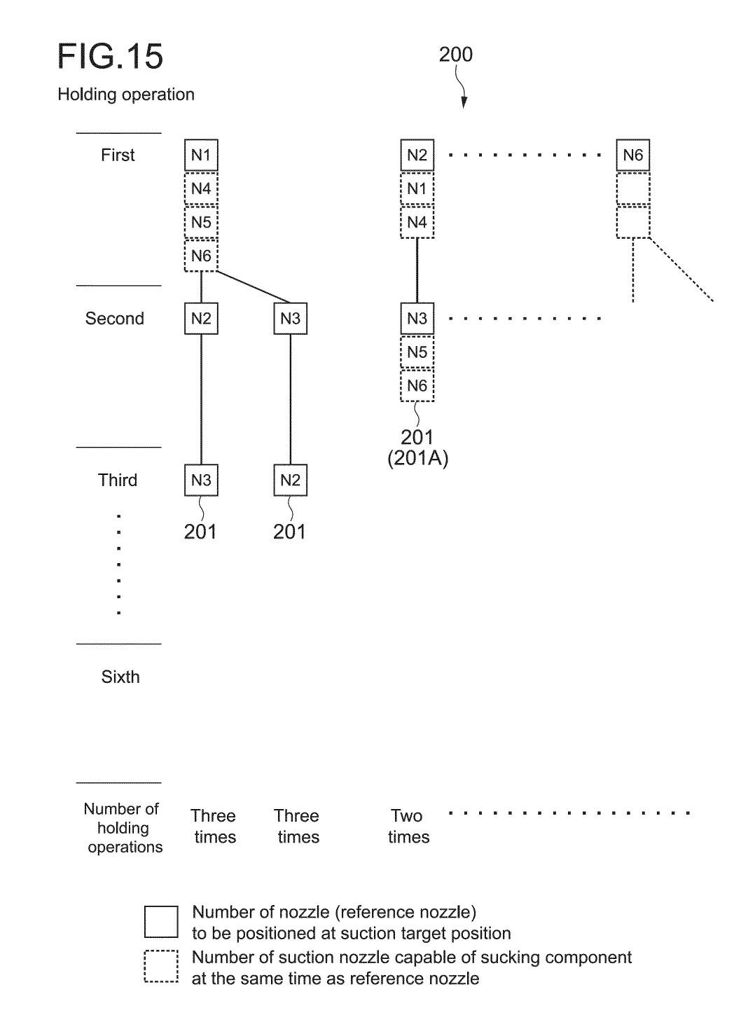

On the other hand, the access positions 36 of the suction nozzles 33 of Nozzle Numbers 2 and 3 depart from the suckable range 51. Therefore, the suction nozzles 33 of Nozzle Numbers 2 and 3 are determined not to be located at the positions at which it is may be impossible to hold the electronic components 50. The determination results of the access positions 36 of the other suction nozzles 33 are registered as a holding-operation combination tree 200 in the estimation processing that is shown in FIG. 15. It should be noted that the storage method for the determination results of the access positions 36 of the other suction nozzles 33 is not limited.

Whether or not all of the suction nozzles 33 are determined to be located at the positions at which the components can be held (Step 304). Since, as described above, the suction nozzles 33 of Nozzle Numbers 2 and 3 are not located within the suckable range, the processing proceeds to Step 305.

In Step 305, suction nozzles (Nozzle Numbers 2 and 3) of the plurality of suction nozzles 33, whose access positions 36 are determined not to be located at the suckable positions, are set as processing targets. Then, with respect to the suction nozzles 33 of Nozzle Numbers 2 and 3, the selection of the reference nozzle 35 and the determination of the access positions 36 of the other suction nozzles 33 in Steps 301 to 303 are performed.

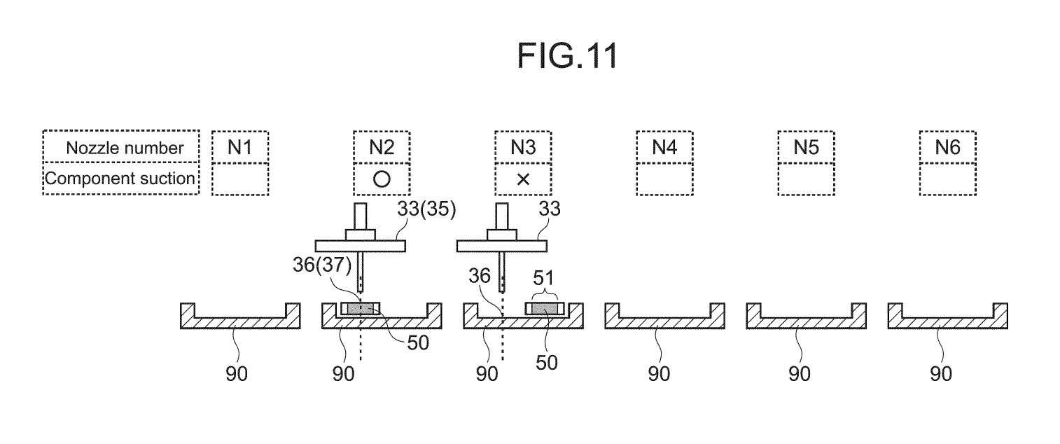

For example, as shown in FIG. 11, the suction nozzle 33 of Nozzle Number 2 is selected as the reference nozzle 35. Then, the access position 36 of the reference nozzle 35 is set to be the suction target position 37 of the electronic component 50. Then, the suction nozzle 33 of Nozzle Number 3 departs from the suckable range 51 of the electronic component 50. Therefore, the suction nozzle 33 of Nozzle Number 3 is determined not to be located at the position in which the electronic component 50 can be held.

Therefore, in Step 305, the suction nozzle 33 of Nozzle Number 3 is set as a processing target and the selection of the reference nozzle 35 and the determination of the access positions 36 of the other suction nozzles 33 are performed.

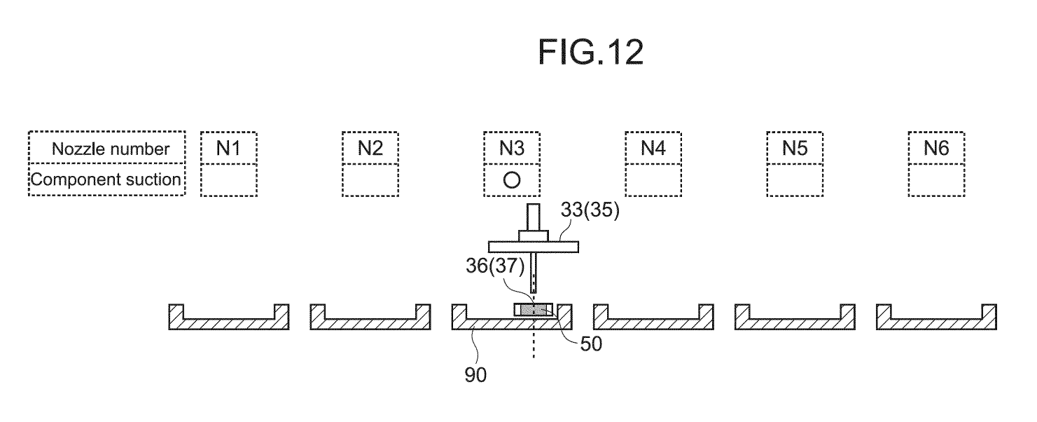

As shown in FIG. 12, the suction nozzle 33 is selected as the reference nozzle 35 and the access position 36 thereof is set to be the suction target position 37 of the electronic component 50. Since no other suction nozzles 33 are present, in Step 304, all of the access positions 36 of the suction nozzles 33 are determined to be located at positions at which the electronic components 50 can be held.

In this manner, until all of the access positions 36 of the suction nozzles 33 are determined to be located at the positions at which the electronic components 50 can be held, the selection of the reference nozzle 35 and the determination of the access positions 36 of the other suction nozzles 33 are performed.

As shown in FIG. 15, every time the determination processing of the access positions 36 of the other suction nozzles 33 is performed, the determination result thereof is registered on the combination tree 200. With this, the suction nozzle 33 of Nozzle Number 1 is first selected as the reference nozzle 35, and a candidate combination 201 being the combination of the holding operations is calculated under setting where the access position 36 of the reference nozzle 35 is set to be the suction target position 37.

When all of the suction nozzles 33 are determined to be located at the positions at which the electronic components 50 can be held, the number of holding operations in the candidate combination 201 is calculated (Step 306). In this embodiment, the number of selections of the reference nozzle 35 in the single candidate combination 201 of the combination tree 200 is calculated as the number of holding operations. Therefore, in the estimation processing shown in FIGS. 10 to 12, three holding operations are calculated. The calculated number of holding operations is registered on the combination tree 200.

Here, in the second selection processing of the reference nozzle 35, a combination in the case where the suction nozzle 33 of Nozzle Number 3 is selected as the reference nozzle 35 is also estimated. Then, the candidate combination 201 and the number of holding operations in such a case are registered on the combination tree 200. In this manner, combination estimation is performed on the fist selected reference nozzle 35 multiple times. With this, it is possible to efficiently estimate the holding operations.

In Step 307 of FIG. 7, whether or not calculation of the candidate combination 201 is terminated is determined. In this embodiment, whether or not the first selection processing of the reference nozzle 35 has been performed on all of the plurality of suction nozzles 33 is determined. That is, if there is the suction nozzle 33 that has not been selected as the first reference nozzle 35, the processing proceeds from No in Step 307 to Step 301.

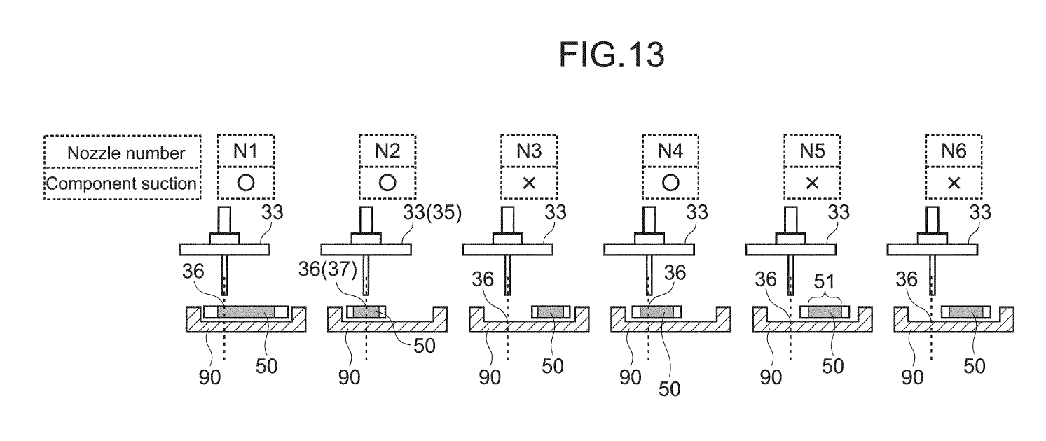

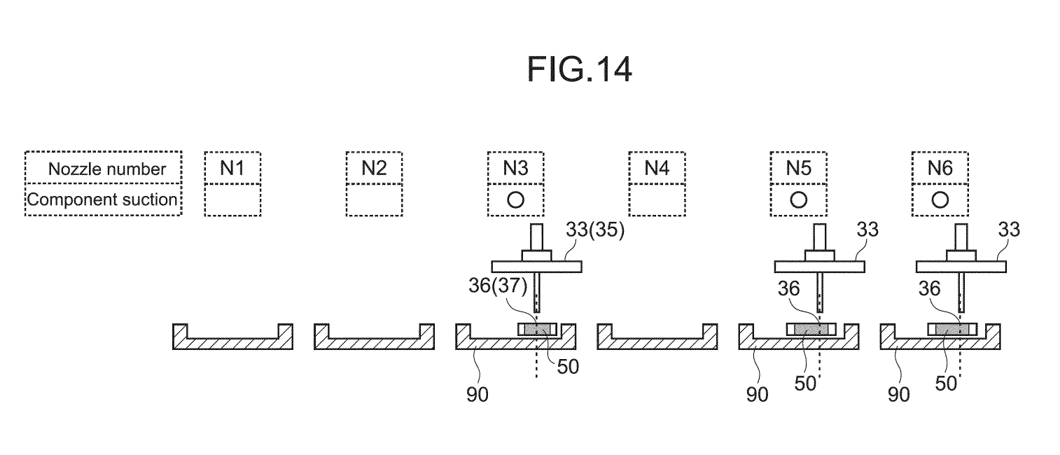

FIGS. 13 and 14 are views for describing a case where the suction nozzle 33 of Nozzle Number 2 is set as the first reference nozzle 35. As shown in FIG. 13, the access position 36 of the reference nozzle 35 is set to be the suction target position 37 of the electronic component 50. Then, the access positions 36 of the suction nozzles 33 of Nozzle Numbers 1 and 4 fall within the suckable range 51. On the other hand, the access positions 36 of the suction nozzles 33 of Nozzle Numbers 3, 5, and 6 depart from the suckable range 51.

As shown in FIG. 14, among the suction nozzles 33 of Nozzle Numbers 3, 5, and 6 determined not to be located at the positions at which the electronic components 50 can be held, the suction nozzle 33 of Nozzle Number 3 is selected as the reference nozzle 35. When the access position 36 of the reference nozzle 35 is set to be the suction target position 37 of the electronic component 50, the access positions 36 of the other suction nozzles 33 (Nozzle Numbers 5 and 6) fall within the suckable range 51 of the electronic component 50. Therefore, all of the suction nozzles 33 are determined to be located at the positions at which the electronic components 50 can be held.

As shown in FIG. 15, the candidate combination 201 and the number of holding operations are registered on the holding-operation combination tree 200. The number of holding operations to be registered is two.

In this manner, the plurality of suction nozzles 33 are sequentially selected as the first reference nozzle 35. Then, when all of the suction nozzles 33 are selected as the first reference nozzle 35, the processing proceeds from Yes in Step 307 to Step 308.

In Step 308, among the plurality of candidate combinations 201 calculated every time the reference nozzle 35 is selected among the plurality of suction nozzles 33, the combination of the holding operations to be actually executed by the mounting head 30 is selected. The combination of the holding operations are selected by referring to the combination tree 200 on which the plurality of candidate combinations 201 have been registered.

In this embodiment, based on the number of holding operations with the candidate combination 201 calculated for each of the candidate combinations 201, the combination of the holding operations is selected. That is, the candidate combination 201 having a smallest number of holding operations is selected as the combination of the holding operations. With this, it is possible to efficiently mount the plurality of electronic components 50 on the substrate W.

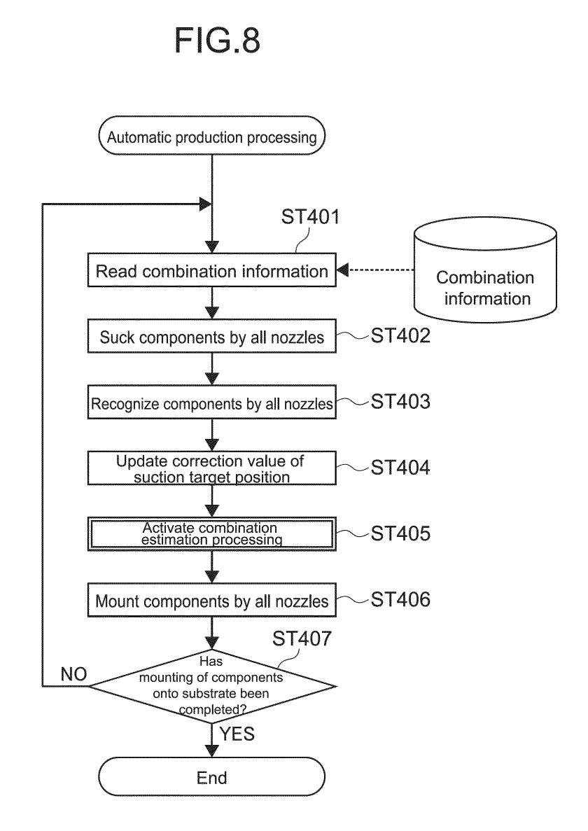

FIG. 8 is a flowchart showing a flow of the automatic production processing according to this embodiment. In this embodiment, the tape feeders 90 supply the plurality of electronic components 50 to the supply area S as first supply. Then, when the plurality of supplied electronic components 50 are held by the plurality of suction nozzles 33, the plurality of electronic components 50 are supplied to the supply area S as second supply. Every time the plurality of electronic components 50 are supplied to the supply area S, the above-mentioned combination estimation processing of the holding operation is performed.

The combination information stored in Step 202 of FIG. 6 is read (Step 401). Based on the read information, using the combination of the holding operations calculated by the combination estimation processing, all of the plurality of suction nozzles 33 hold the plurality of electronic components (Step 402).

For example, in the case where a candidate combination 201A shown in FIG. 15 is selected as the combination of the holding operations, the mounting head 30 is moved so that the access position 36 of the suction nozzle 33 of Nozzle Number 2 is first set to be the suction target position 37 of the electronic component 50. Then, the suction nozzles 33 of Nozzle Numbers 1, 2, and 4 perform the component suction. Subsequently, the mounting head 30 is moved so that the access position 36 of the suction nozzle 33 of Nozzle Number 3 is set to correspond to the suction target position 37 of the electronic component 50. Then, the suction nozzles 33 of Nozzle Numbers 3, 5, and 6 perform the component suction. As a result, all of the suction nozzles 33 hold the plurality of electronic components 50.

Component recognition processing is performed on all of the suction nozzles 33 (Step 403). The component recognition is performed by the component camera 32 shown in FIG. 2 imaging the electronic components 50 sucked by the suction nozzles 33.

The taken image of the electronic components 50 is analyzed and the suction positions being the holding positions of the suction nozzles 33 with respect to the electronic components 50 are calculated. For example, the component camera 32 images the electronic component 50 from below such that the position of the suction nozzle 33 is located in the center. Based on the position of the electronic component 50 in the image thereof, the suction position is calculated. However, the calculating method for the suction position is not limited.

Based on information on the calculated suction position, the correction value for the suction target position 37 is updated (Step 404). In the combination estimation processing on the plurality of electronic components 50 supplied in the first supply, the suction positions of the suction nozzles 33 are also estimated. A difference between the estimated suction position and the actual suction position calculated in Step 403 is calculated as the correction value for the suction target position 37.

For example, as in Step 103 of the automatic-production preparation processing shown in FIG. 5, the image of the supply area S including the plurality of electronic components 50 supplied in the second supply may be taken by the substrate camera 17. Then, the position information of the plurality of electronic components 50 in the second supply may be obtained and the correction value of the suction target position 37 may be updated. With this, it is possible to obtain correct position information.

On the other hand, in this embodiment, based on the suction positions of the plurality of suction nozzles 33 calculated in Step 403, the position information of the plurality of electronic components 50 in the second supply is obtained, and the correction value for the suction target position 37 is updated. With this, the position information of the plurality of electronic components 50 to be supplied to the supply area S is obtained for a short time, and hence a throughput is increased.

That is based on the fact that the electronic components 50 of the same kind to be housed in the single tape feeder 90 are each supplied to the supply area S at substantially the same position in each supply window 91. For example, in some cases, the tape feeder 90 attached to the mounting portion 20 is slightly tilted. In these cases, the electronic component 50 housed in the tape feeder 90 may be slightly deviated from the center position 53 of the supply window 91. However, this deviation often occurs in the electronic components 50 of the same kind housed in the tape feeder 90 in substantially the same manner. That is, with respect to the electronic components 50 housed in the single tape feeder 90, misalignment thereof can be considered to occur with a certain tendency. Therefore, based on the suction position according to the first supply, the position information of the plurality of electronic components 50 according to the second supply can be obtained.

The combination estimation processing is activated (Step 405). With this, the combination estimation processing shown in FIG. 6 is performed. Here, only the activation of the combination estimation processing is performed and mounting processing of the plurality of electronic components 50 according to the first supply, which have been sucked in Step 402, on the substrate W is performed (Step 406). In this manner, the combination estimation processing is performed in parallel with the automatic production processing, and hence the throughput is not lowered in the production for the substrate.

Whether or not the mounting of the electronic components 50 on the substrate W has been completed is determined (Step 407). That is, whether or not all of the electronic components 50 to be mounted have been mounted is determined. When it is determined that the mounting of the electronic components 50 has not been completed, the processing is repeated from Step 401. When it is determined that the mounting of the electronic components 50 has been completed, the automatic production processing for the substrate is terminated.

It should be noted that, in the first supply and the second supply described above, the electronic components 50 of the same kind are supplied from the single tape feeder 90. However, the first supply and the second supply are not limited only to be successively performed. For example, the following case is also assumed. With respect to a first substrate W, a plurality of electronic components 50 are picked up from a predetermined tape feeder 90 and the plurality of electronic components are mounted (mounting A). Next, a plurality of electronic components 50 are picked up from another tape feeder 90 and mounted on the substrate W (mounting B), and mounting processing on the substrate W is completed. After that, with respect to a second substrate W, the mounting A and the mounting B are performed. In such a case, for example, the mounting A on the first substrate W corresponds to the first supply and the mounting A on the second substrate W corresponds to the second supply.

As described above, in the component mounting apparatus 100 according to this embodiment, based on the position information of the plurality of electronic components 50 supplied to the supply area S, the combination of the at least one or more holding operations necessary for all of the plurality of suction nozzles 33 to hold the plurality of electronic components 50 is calculated. With this, it is possible to efficiently mount the plurality of electronic components 50 on the substrate W even when the plurality of electronic components 50 supplied to the supply area S are misaligned. Further, it is possible to mount the plurality of electronic components 50 on the substrate W for a short time, and hence to enhance productivity of the substrate W.

Further, in the component mounting apparatus 100, the reference nozzle 35 is selected and the access position 36 of the reference nozzle 35 is set to be a position at which the electronic component 50 can be held. Under this setting, the combination of the holding operations for holding the plurality of electronic components 50 is calculated as the candidate combination 201. With this, among the plurality of candidate combinations 201 calculated every time the reference nozzle 35 is selected, the combination of the holding operations is appropriately selected. As a result, it is possible to efficiently mount the plurality of electronic components 50 on the substrate W.

Further, in the component mounting apparatus 100, until the access positions 36 of all of the suction nozzles 33 are determined to be located at the positions at which the electronic components 50 can be held, the selection of the reference nozzle 35 and the determination of the access positions 36 of the other suction nozzles 33 are performed. That is, by repeating the selection of the reference nozzle 35 and the determination of the access position 36, it is possible to easily calculate the candidate combinations 201. As a result, it is possible to suppress loads on processing resources such as the CPU and the RAM of the main controller 21.

### Modified Example

Embodiments of the present disclosure are not limited to the above-mentioned embodiment and can be variously modified.

For example, in the above-mentioned embodiment, with the access position 36 of the selected reference nozzle 35 being set to be the suction target position 37, the candidate combination 201 is calculated. Here, the access position 36 of the reference nozzle 35 may be set to be different positions within the suckable range 51 of the electronic component 50 multiple times. Then, for each of the settings at the different positions, the candidate combination 201 may be calculated.

For example, there may be a case where, when the access position 36 of the reference nozzle 35 is set to be different positions, the number of other suction nozzles 33 having the access position 36 falling within the suckable range 51 is increased. Then, for some settings of the access position 36, the candidate combination 201 including a smaller number of holding operations may be calculated. As a result, the combination of a smaller number of holding operations can be calculated.

The processing of setting the access position 36 of the reference nozzle 35 within the suckable range 51 multiple times is not limited to be performed on the first selected reference nozzle 35. The access position 36 of the second selected reference nozzle 35 and the subsequent selected reference nozzles 35 may also be set within the suckable range 51 multiple times. With this, the combination of the holding operations for efficiently sucking the plurality of electronic components 50 is calculated.

In the above, in the correction value update processing shown in Step 404 of FIG. 8, the difference between the estimated suction position and the actual suction position is calculated as the correction value for the suction target position 37. Such a correction value may be calculated as follows.

Every time the plurality of electronic components 50 supplied to the supply area S are held by the plurality of suction nozzles 33, the imaging of the component camera 32 is performed and the difference between the estimated suction position and the actual suction position is calculated and stored. An average of the stored differences may be calculated in order to calculate the correction value based on this average value. Hereinafter, the difference between the estimated suction position and the actual suction position is referred to as a position difference.

For example, the average of the position differences in a predetermined number (hereinafter, referred to as n-times) of the suction operations previously performed is calculated. This average of the position differences may be calculated as the correction value as it is. Alternatively, a predetermined percentage (hereinafter, referred to as m %) of the calculated average of the position differences may be calculated as the correction value. That is, m % of the average of the position differences in the previous n-times may be calculated as the correction value.

Among the plurality of electronic components 50 housed in the single tape feeder 90, there may be an electronic component 50 housed at a largely different position in comparison with the other electronic components 50 for some reasons. In other words, there may be the electronic component to which a tendency that can be seen at the housing positions of the plurality of electronic components 50 is not applied.

In such a case, there is a possibility that the position information of such an electronic component 50 housed at the different position strongly affects the calculation of the position information of the electronic components 50 to be supplied thereafter. However, by calculating the correction value using the average of the position differences, such an influence can be suppressed. It is possible to accurately obtain the position information of the plurality of electronic components 50 supplied to the supply area S.

In the above, in Step 307 of FIG. 7, whether or not the selection processing of the first reference nozzle 35 has been performed on all of the plurality of suction nozzles 33 is determined. However, at a time when the candidate combination 201 including a predetermined number of holding operations or a smaller number of holding operations is calculated, it may be determined that the calculation of the candidate combination 201 is terminated. For example, when such a candidate combination 201 that all of the suction nozzles 33 can hold the electronic components 50 in a single holding operation is calculated, then, it may be determined that the calculation processing of the candidate combination 201 is terminated. Further, for example, in the case where a huge number of suction nozzles 33 are used, at a time when a predetermined number of suction nozzles 33 have been selected as the reference nozzle 35, it may be determined that the calculation of the candidate combination 201 is terminated. With this setting, the throughput can be increased.

In the above, the main controller 21 serving as the control unit that is shown in FIG. 4 performs the calculation processing of the combination of the holding operations based on the position information of the plurality of electronic components 50. The calculation processing of the combination of the holding operations described above may be performed as an information processing method according to an embodiment of the present disclosure.

Further, a computer including the above-mentioned main controller 21 may be used as an information processing apparatus for controlling the component mounting apparatus, according to an embodiment of the present disclosure. In this case, the main controller 21 functions as an acquisition unit and a calculation unit.

It should be noted that the present disclosure may also be configured as follows.

(1) A component mounting apparatus, including:

a supply unit configured to supply a plurality of components to be mounted on a substrate, to a predetermined area;

a head including a plurality of holders for holding the plurality of supplied components and being configured to support the plurality of holders such that the plurality of holders can simultaneously access the predetermined area; and

a control unit configured to calculate, based on position information of the plurality of components with respect to the predetermined area, a combination of at least one or more holding operations necessary for the plurality of holders to hold the plurality of components, the at least one or more holding operations being performed with access positions of the plurality of holders being fixed.

(2) The component mounting apparatus according to (1), in which

the control unit is configured to
select a reference holder to be a reference among the plurality of holders,
calculate a candidate combination being the combination of the holding operations with the access position of the reference holder being set to be a position at which the component can be held, and
select the combination of the holding operations among a plurality of candidate combinations calculated every time the reference holder is selected among the plurality of holders.
   (3) The component mounting apparatus according to (2), in which

the control unit is configured to
calculate the number of holding operations for each of the candidate combinations, and
select the combination of the holding operations based on the calculated number of holding operations.
   (4) The component mounting apparatus according to (2) or (3), in which

the control unit is configured to
determine the access positions of the other holders with the access position of the reference holder being set to be the position at which the component can be held,
perform selection of the reference holder and determination of the access positions of the other holders on the holder whose access position is determined not to be located at the position at which the component can be held among the other holders, and
calculate the candidate combinations by performing selection of the reference holder and determination of the access positions of the other holders until the access positions of all of the holders are determined to be located at the positions at which the components can be held.
   (5) The component mounting apparatus according to any one of (2) to (4), in which

the control unit is configured to
calculate, based on information on the kinds of the plurality of components, a range of positions at which the components can be held for each of the kinds, and
set the access position of the reference holder to different positions within the range of the positions at which the components can be held multiple times, to thereby calculate the candidate combinations for each of settings at the different positions.
   (6) The component mounting apparatus according to any one of (1) to (5), further including:

an imaging unit configured to be capable of taking an image of the predetermined area, in which

the control unit is configured to obtain the position information of the plurality of components based on the image of the predetermined area that is taken by the imaging unit, to which the plurality of components are supplied.

(7) The component mounting apparatus according to any one of (1) to (6), in which

the supply unit is configured to supply, when the plurality of components supplied as first supply are held by the plurality of holders, the plurality of components to the predetermined area as second supply, and

the control unit is configured to
obtain information on the holding positions of the plurality of holders with respect to the plurality of components supplied as the first supply, and
obtain, based on the information on the holding positions, position information of the plurality of components supplied as the second supply.

The present disclosure contains subject matter related to that disclosed in Japanese Priority Patent Application JP 2011-238527 filed in the Japan Patent Office on Oct. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A component mounting apparatus, comprising:
a supply unit configured to supply a plurality of components to be mounted on a substrate, to a predetermined area;
a head including a plurality of holders for holding the plurality of supplied components and being configured to support the plurality of holders such that the plurality of holders can simultaneously access the predetermined area; and
a control unit configured to calculate, based on position information of the plurality of components with respect to the predetermined area, a combination of at least one or more holding operations necessary for the plurality of holders to hold the plurality of components, the at least one or more holding operations being performed with access positions of the plurality of holders being fixed.

2. The component mounting apparatus according to claim 1, wherein
the control unit is configured to
select a reference holder to be a reference among the plurality of holders,
calculate a candidate combination being the combination of the holding operations with the access position of the reference holder being set to be a position at which the component can be held, and
select the combination of the holding operations among a plurality of candidate combinations calculated every time the reference holder is selected among the plurality of holders.

3. The component mounting apparatus according to claim 2, wherein
the control unit is configured to
calculate the number of holding operations for each of the candidate combinations, and
select the combination of the holding operations based on the calculated number of holding operations.

4. The component mounting apparatus according to claim 2, wherein
the control unit is configured to
determine the access positions of the other holders with the access position of the reference holder being set to be the position at which the component can be held,
perform selection of the reference holder and determination of the access positions of the other holders on the holder whose access position is determined not to be located at the position at which the component can be held among the other holders, and
calculate the candidate combinations by performing selection of the reference holder and determination of the access positions of the other holders until the access positions of all of the holders are determined to be located at the positions at which the components can be held.

5. The component mounting apparatus according to claim 2, wherein
the control unit is configured to
calculate, based on information on the kinds of the plurality of components, a range of positions at which the components can be held for each of the kinds, and
set the access position of the reference holder to different positions within the range of the positions at which the components can be held multiple times, to thereby calculate the candidate combinations for each of settings at the different positions.

6. The component mounting apparatus according to claim 1, further comprising:
an imaging unit configured to be capable of taking an image of the predetermined area, wherein
the control unit is configured to obtain the position information of the plurality of components based on the image of the predetermined area that is taken by the imaging unit, to which the plurality of components are supplied.

7. The component mounting apparatus according to claim 1, wherein
the supply unit is configured to supply, when the plurality of components supplied as first supply are held by the plurality of holders, the plurality of components to the predetermined area as second supply, and
the control unit is configured to
obtain information on the holding positions of the plurality of holders with respect to the plurality of components supplied as the first supply, and
obtain, based on the information on the holding positions, position information of the plurality of components supplied as the second supply.

8. An information processing apparatus that is used for a component mounting apparatus including
a supply unit configured to supply a plurality of components to be mounted on a substrate, to a predetermined area, and
a head including a plurality of holders for holding the plurality of supplied components and being configured to support the plurality of holders such that the plurality of holders can simultaneously access the predetermined area, the information processing apparatus comprising:
an acquisition unit configured to obtain position information of the plurality of components with respect to the predetermined area; and
a calculation unit configured to calculate, based on the position information obtained by the acquisition unit, a combination of at least one or more holding operations necessary for all of the plurality of holders to hold the plurality of components, the at least one or more holding operations being performed with the access positions of the plurality of holders being fixed.

9. An information processing method that is performed by a component mounting apparatus including
a supply unit configured to supply a plurality of components to be mounted on a substrate, to a predetermined area, and
a head including a plurality of holders for holding the plurality of supplied components and being configured to support the plurality of holders such that the plurality of holders can simultaneously access the predetermined area, the information processing method comprising:
obtaining position information of the plurality of components with respect to the predetermined area; and
calculating, based on the obtained position information, a combination of at least one or more holding operations necessary for all of the plurality of holders to hold the plurality of components, the at least one or more holding operations being performed with the access positions of the plurality of holders being fixed.

10. A production method for a substrate that is performed by a component mounting apparatus including
a supply unit configured to supply a plurality of components to be mounted on a substrate, to a predetermined area, and
a head including a plurality of holders for holding the plurality of supplied components and being configured to support the plurality of holders such that the plurality of holders can simultaneously access the predetermined area, the production method comprising:
calculating, based on position information of the plurality of components with respect to the predetermined area, a combination of at least one or more holding operations necessary for all of the plurality of holders to hold the plurality of components, the at least one or more holding operations being performed with the access positions of the plurality of holders being fixed; and
holding the plurality of components by the plurality of holders with the calculated combination of the holding operations and mounting the plurality of held components on the substrate.
